(19) United States
(12) Patent Application Publication
(10) Pub. No.: US 2025/0018359 A1
(43) Pub. Date: Jan. 16, 2025

(54) CONTINUOUS CHEMICAL PROCESSING APPARATUS AND METHOD

(71) Applicant: Zaiput Flow Technologues, Waltham, MA (US)

(72) Inventors: Andrea ADAMO, Cambridge, MA (US); Robert Paul VIANO, Medford, MA (US); Lorenzo MILANI, Woburn, MA (US); Colin O'SHEA, Somerville, MA (US)

(73) Assignee: Zaiput Flow Technologues, Waltham, MA (US)

(21) Appl. No.: 18/705,220

(22) PCT Filed: Oct. 28, 2022
(86) PCT No.: PCT/US2022/048144

§ 371 Date: Apr. 26, 2024

Related U.S. Application Data
(60) Provisional application No. 63/290,574, filed on Dec. 16, 2021.
(60) Provisional application No. 63/273,431, filed on Oct. 29, 2021.

(51) Int. Cl. B01J 19/18; B01J 19/00

(52) U.S. Cl. CPC B01J 19/1862; B01J 19/002; B01J 19/0066; B01J 2219/00033; B01J 2219/0004; B01J 2219/00164

(57) ABSTRACT

An apparatus for carrying out continuous precipitation or chemical reaction involving solids is provided. The apparatus includes a plurality of serially connected chambers. One or more of the chambers includes a volume reducer for decreasing and increasing the volume of a chamber to produce a pulse of fluid to downstream chambers.

### TECHNICAL FIELD

The present disclosure generally relates to precipitation of compounds from a fluid and continuous chemical reactions involving solids. Specifically, the present disclosure is directed to continuous precipitation methods and to an apparatus for performing continuous precipitation as well as continuous chemical reactions.

### BACKGROUND

Precipitation of solutes from solution has been used to produce and purify both organic and inorganic compounds. Precipitation or specifically crystallization can be done using continuous or batch methods, and both techniques have been used in the pharmaceutical industry. Batch and continuous methods each introduce tradeoffs, particularly between efficiency and purity. Keeping solids moving in continuous reaction or precipitation systems presents numerous technical challenges.

### SUMMARY

In one aspect a continuous chemical processing apparatus is provided, the apparatus comprising a linear plurality of chambers including first and last chambers in fluid communication, an inlet in fluid communication with the first chamber, a plurality of agitators, each of the plurality of agitators disposed in one of the plurality of chambers, and wherein at least one of the plurality of chambers is constructed and arranged to hold both a first volume and a second volume, the second volume less than the first volume. The first volume can be at least 5%, 10%, 15%, 20%, 50%, 80%, 90% or 95% greater than the second volume. A volume modulator can be included wherein the volume modulator is configured and arranged to change the volume of the chamber. The chambers of the apparatus are in serial fluid communication, and a liner can be in contact with a surface of at least one of the plurality of chambers. The liner can be flexible and may flex when the volume of the first chamber is changed. The housing is comprised of at least one of a metal, an alloy, a ceramic, a polymer and glass. The chambers can be arranged linearly in relation to one another when the apparatus in operation, and can be, for example, vertically or horizontally aligned. The housing can include a first portion and a second portion, the first and second portions reversibly connected to form a fluid seal. A microprocessor can be included for controlling the volume modulator. The volume modulator can expand the volume of the chamber at a rate that does not exceed, or is equal to, a rate of solution inflow. The volume modulator can be a piston, a bladder, a mechanical roller, a pressurized fluid or a diaphragm. Agitation can be introduced with impellers that can be driven by a common shaft. The apparatus can include at least 3 chambers, at least 5 chambers, at least 10 chambers or at least 20 chambers, and one or more of the chambers can be substantially spherical. The chambers can be fluidly connected by a passageway connecting one chamber to a next chamber or by direct overlap of the volume of adjacent chambers. The volume of at least one of the chambers, or each of the chambers, can be less than 10 L, less than 1 L, less than 500 mL, less than 250 mL, less than 100 mL, less than 50 mL, less than 25 mL, greater than 1 mL, greater than 5 mL, greater than 10 mL, greater than 50 mL, greater than 100 mL, greater than 500 mL, greater than 1 L, greater than 5 L or greater than 10 L. The apparatus can include a volume modulator configured and arranged to change either the first volume, the second volume, or both, and the modulator can change a first volume or a second volume in a first chamber, a final chamber or an intermediate chamber. The apparatus can include a cooler or heater in thermal communication with one or more chambers.

In another aspect, the described apparatus provides a way to move a liquid containing solids within the device. This apparatus can be used to perform chemical reactions that produce solids or entail interaction with solids or require solids as a reagent or catalyst.

In another aspect, a method of continuously precipitating a substance from a fluid is provided, the method comprising passing the fluid into a first chamber and a plurality of secondary chambers downstream of the first chamber, the secondary chambers in fluid communication with the first chamber, precipitating a portion of the substance in at least one of the chambers, the at least one of the chambers having zero headspace, decreasing a starting volume of the at least one chamber to force fluid and precipitate from the at least one chamber into an adjacent secondary chamber, and increasing the volume of the at least one chamber to at least 90% of the starting volume at a rate less than or equal to a rate of fluid entry into the at least one chamber. The fluid can be a solution that can be supersaturated. Decreasing the volume can be performed at a faster rate than increasing the volume. During operation of the device, the amount of volume change, the decreasing rate and increasing rate can be changed. The volume of the first chamber can be decreased by extending a piston, expanding a bladder and/or flexing a liner disposed in the first chamber. The precipitated substance can be a pharmaceutical. The fluid can pass vertically upward from the first chamber to the plurality of secondary chambers. Antisolvent can be flowed into at least one of the chambers. The fluid in at least one of the chambers can be cooled. The solution can be fed to more than one chamber. The solution in one, more than one, or all of the chambers can be agitated. The decrease in starting volume can be between 3 and 20% of the starting volume of the first chamber, and the decrease can be complete in less than 5 seconds, less than 2 seconds, less than 1 second, less than 0.5 second, greater than 0.1 seconds, greater than 0.3 seconds, greater than 0.5 seconds or greater than 1 second. The decrease in volume can result in pulses of fluid and precipitate from the first chamber to the second chamber and the pulses can be repeated more than one, more than two, more than three or more than 10 times per minute. In the same and other embodiments, the pulses of fluid and precipitate can proceed at rates less than 1 per day, less than 10 per day, less than 1 per hour or less than 10 per hour.

In another aspect, a method of facilitating a chemical reaction involving solids is provided, the method comprising passing a fluid into a first chamber and a plurality of secondary chambers downstream of the first chamber, the secondary chambers in fluid communication with the first chamber, allowing two or more reactants to react in the fluid, producing a solid product in one or more chambers, decreasing a starting volume of the first chamber to force fluid and solid product from the first chamber into an adjacent secondary chamber, and increasing the volume of the first chamber to the starting volume at a rate less than or equal to a rate of fluid entry into the first chamber. The chambers can be vertically aligned or horizontally aligned. The apparatus can include a check valve in the flow path between adjacent chambers, the check valve configured and arranged to prevent backflow of fluid from a downstream chamber to an upstream chamber. The apparatus can have a plurality of check valves. A check valve can be a passive check valve, or the check valve can be an active check valve. In various embodiments the apparatus can comprise means for preventing backflow between two adjacent chambers.

In another aspect, a method of facilitating a chemical reaction involving solids is provided, the method comprising passing a fluid comprising a solid reactant into a first chamber and a plurality of secondary chambers downstream of the first chamber, the secondary chambers in fluid communication with the first chamber, allowing the solid reactant to react with one or more secondary reactants, decreasing a starting volume of the first chamber to force the fluid and solid reactant from the first chamber into an adjacent secondary chamber, and increasing the volume of the first chamber to the starting volume at a rate less than or equal to a rate of fluid entry into the first chamber. Decreasing the volume can be performed at a faster rate than increasing the volume. The method can include repeating the decreasing of volume at a different rate or by a different volume than the first time. The volume of the first chamber can be decreased by extending a piston, expanding a bladder and/or flexing a liner disposed in the first chamber. The fluid can pass vertically upward from the first chamber to the plurality of secondary chambers. The methods can include flowing additional reactants into at least one of the chambers, cooling the fluid in at least one of the chambers, directly feeding the fluid to more than one chamber, agitating fluid in one, more than one, or all of the chambers. The methods may also provide a decrease in starting volume between 3 and 20% of the starting volume of the first chamber. The decrease in volume can be complete in less than 5 seconds, less than 2 seconds, less than 1 second, less than 0.5 second, greater than 0.1 seconds, greater than 0.3 seconds, greater than 0.5 seconds or greater than 1 second. The decrease in volume can result in pulses of fluid and precipitate from the first chamber to the second chamber and wherein the pulses are repeated more than one, more than two, more than three or more than 10 times per minute. The decrease in volume can result in pulses of fluid and precipitate from the first chamber to the second chamber at rates less than 1 per day, less than 10 per day, less than 1 per hour or less than 10 per hour. The fluid can be a solution, a dispersion and/or a suspension. The method can include a decrease in volume that results in pulses of fluid and precipitate from the first chamber to the second chamber at rates less than 1 per day, less than 10 per day, less than 1 per hour or less than 10 per hour. The volume of the first chamber can be increased to at least 95%, 98%, 99% or 100% of the original volume. The fluid can comprise a liquid, the fluid can be a solution and the fluid can be a mixture.

### BRIEF DESCRIPTION OF THE DRAWINGS

FIG. 1 is a schematic diagram of an embodiment of a continuous precipitation apparatus;

FIG. 2 is a schematic diagram of a second embodiment of a continuous precipitation apparatus;

FIG. 3 is a schematic diagram of a third embodiment of a continuous precipitation apparatus; and

FIG. 4 is a flow chart illustrating one embodiment of a process for continuous precipitation.

The figures depict various embodiments of the present disclosure for purposes of illustration only. Numerous variations, configurations, and other embodiments will be apparent from the following detailed discussion.

### DETAILED DESCRIPTION

In one aspect, a continuous crystallizer is disclosed that can be scaled up to production size or down to laboratory scale and can maximize retention time while maintaining a high level of crystal purity. The continuous crystallizer can be used in a number of industries including pharmaceuticals, fine and specialty chemicals, natural products, biologics, food and beverage and chemical synthesis and purification. The system can be used with different fluids including liquids, solutions and mixtures.

In one set of embodiments, the device can include a set of linked chambers that are in serial fluid communication. The chambers can be of a same or similar shape and volume and can have an absence of corners. For instance, the chambers can be spherical, or egg shaped. One or more chambers can be of variable volume. For example, a chamber can include a movable surface such as a diaphragm or a piston that can be activated to move inwardly and thereby reduce the volume of the chamber. This reduction in volume can cause a sudden increase in flow (pulse) from the chamber to a second (and third and fourth and more) chamber that is in fluid communication with the first chamber. An absence of headspace in the chamber(s) dictates that a decrease in volume results in an instantaneous outflow of fluid, such as water. This pulse of liquid and suspended solids can help transport solution and precipitate to the next chamber without clogging. After the pulse of flow, the diaphragm or piston can be retracted, resulting in an increase in volume of the chamber, typically back to its original volume. The increase in volume of the chamber can be made up by solution or other liquid that is fed to the first chamber through an orifice, passageway or valve.

In other embodiments, the device is used to carry out a chemical reaction that produces solids or that needs a solid reagent. The controlled reduction of volume in the first chamber allows for movement of the slurry within the device. Reagents can be mixed in the first chamber, or in one or more of the other chambers.

“Precipitation,” as used herein, includes initial formation and/or growth of a solid material. Precipitation can be “seeded” (where there is initially a solid present, and that solid grows via subsequent deposition of solid material on the initial material to form a larger solid material) or “unseeded” (where there is initially no solid present, but solid forms from solubilized or otherwise non-solid components of an initial solution or other precursor-containing liquid). “Crystallization” is a subset of precipitation that involves the initial formation and/or growth of crystalline solid material. Crystallization can be seeded or unseeded. Crystallization can result in the formation of a polycrystalline material or single crystalline particles. In some cases, both crystalline and amorphous material can be formed.

Continuous precipitation processes differ from batch precipitation. In continuous precipitation a solution of the product to be precipitated is fed into the system, while concurrently precipitate, such as crystals, is removed from the system such that the total volume of the liquid being processed is essentially constant. For instance, during continuous precipitation, the volume of the system may vary by less than 1%, less than 5%, less than 10%, less than 20% or less than 30% during the process. In batch crystallization the inflows and outflows are not concurrent. Continuous processes can avoid batch-to-batch variability but typically produce lower yields than do batch processes. The quality of the precipitate, e.g., a crystallized material, is evaluated by measuring a number of features including, for example, purity, particle size, morphology, polymorphism, optical density, chirality and yield. Continuous tubular crystallizers can be categorized as plug flow, segment flow, or oscillatory baffled crystallizers. Segment flow and plug flow have not been shown to work well on a smaller laboratory scale (e.g., less than 1 L). Oscillation techniques can theoretically work on a laboratory scale, but, to date, oscillation techniques and apparatuses have been unsuccessful at achieving consistent laboratory scale practice. The apparatuses and techniques described herein provide scalable methods for efficient crystallization that can improve, for example, yield, purity, particle size and morphology when compared to these known techniques.

### Overview

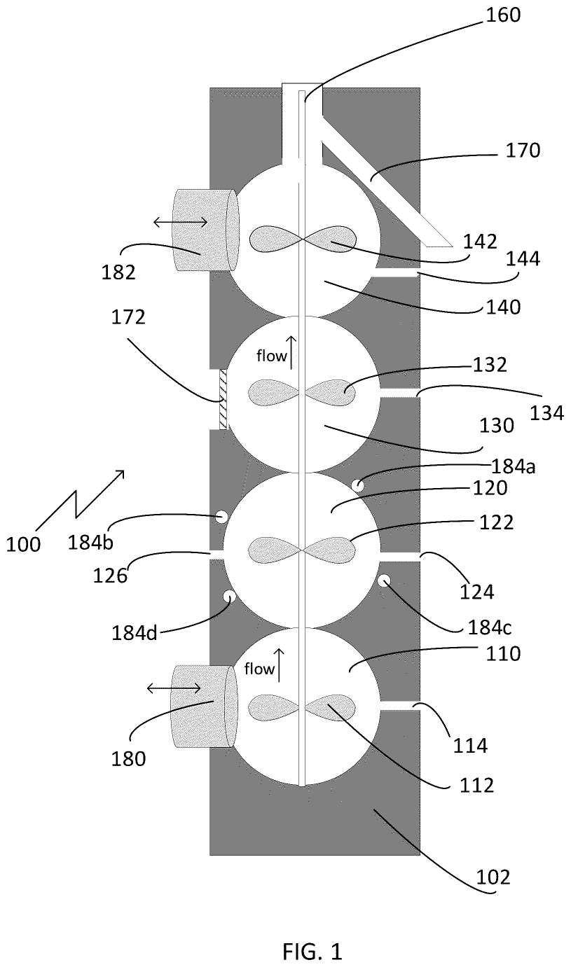

A schematic diagram of one embodiment of a continuous precipitation apparatus 100 is illustrated in FIG. 1. The figure includes a housing 102 that defines spherical chambers 110, 120, 130 and 140. Also shown are inlets 114 and 124, 134, 144 as well as outlet 170. Piston 180 is slidably movable and its movement into and out of the chamber can decrease and increase the volume of first chamber 110. Agitators, in this case impellers 112, 122, 132 and 142, are disposed in chambers 110, 120, 130 and 140 respectively. The impellers may be driven individually and can be driven by common driveshaft 160. As shown, fluid can pass upwardly from chamber 110 to 120 to 130 to 140. As shown, the chambers are in direct fluid communication with each other and do not require optional transfer tubes in order to move material from one chamber to the next.

Housing 102 can be made from any material capable of containing the chambers and supporting the impellers, pumps, pistons and other ancillary parts. It can be any shape that supports the chambers and as shown in FIG. 1 can be cylindrical. The material can be corrosion resistant and should be free of substances that can contaminate the solution that flows through the chambers. Appropriate materials include metals, alloys, ceramics, glass, polymers and reinforced polymers. Specific examples include stainless steel, steel alloys, Hastelloy, aluminum, titanium, PTFE, ETFE, PVDF, PP, PEEK, FEP, PFA, glass reinforced polymers, glass and ceramics. The housing can be molded or can be machined from a block of material. In some embodiments it can be 3D printed. The chambers may be molded or machined into the material and may include surface treatments such as anodization, electrodeposition, electropolishing, painting and coating with specialty materials or polymers.

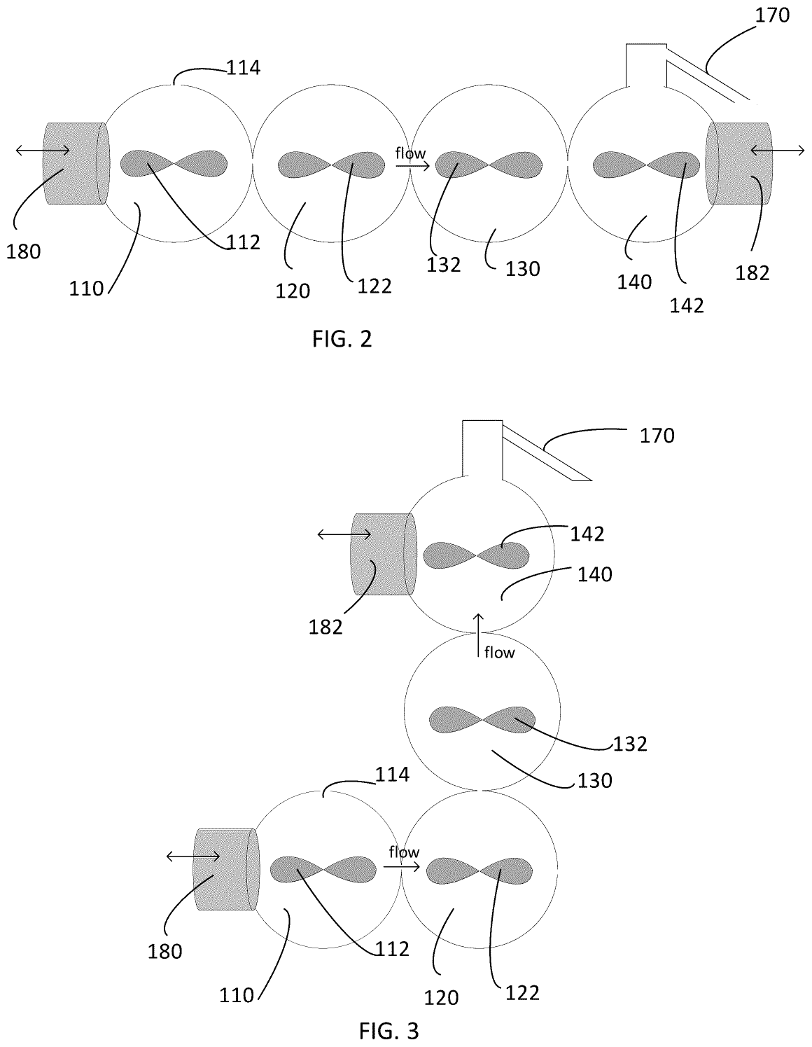

Housing 102 can include any number of chambers such as 110, 120, 130 and 140. The chambers may be linearly arranged and can be similarly or identically sized to promote consistent residence time in each. Linearly arranged means that the output from one chamber leads to an input of a second chamber, the output from the second chamber leads to an input of a third chamber and continues in this manner until the n^{th} chamber. Chamber size can be varied when, for instance, residence time should be varied. As the number of chambers increases, the residence time distribution (RTD) becomes tighter. In various embodiments, the apparatus can include greater than 2, greater than 3, greater than 5, greater than 10, greater than 15, greater than 20 or greater than 25 chambers. Chambers can be arranged vertically, as shown in FIG. 1, can be arranged horizontally as shown in the embodiment of FIG. 2, or can be arranged in a combination of vertical and horizontal, an embodiment of which is illustrated in FIG. 3. In some cases, all chambers are arranged horizontally. In other cases all chambers are arranged vertically. In one embodiment the chambers are individual modules and can be joined vertically or horizontally in different arrays like building blocks. In some embodiments, adjacent chambers are in fluid communication with each other, and there is zero distance between adjacent chambers. This geometry can provide for the elimination of transfer tubes, passageways or channels that can clog or retard the flow of crystals or other precipitate from one chamber to the next. During operation, chambers may include little or no headspace. In some cases, all chambers, except optionally the final dispensing chamber, may be void of headspace, and there may be no headspace during operation from the entrance point of the solution up to the final chamber (crystal exit).

Housing 102 can include observation window 172 in or adjacent to one, two or more of the chambers. To improve observation, a light can be positioned to illuminate at least a portion of the chamber, for example, opposite the observation window. In addition, one or more of the chambers can include sensors to provide real time analysis of the process. Parameters that can be measured before, during and/or after precipitation or reaction include, for example, flow, temperature, pressure, turbidity, particle count and particle size. To enable real time monitoring of the process, one or more chambers may include lights, lasers, optical sensors, thermometers, pressure sensors, flow meters, particle counters, PAT probes, particle size analyzers and turbidity sensors.

In some embodiments, the housing can include a liner that provides a barrier between the wall of one or more chambers and the inner space of the chamber where fluid is processed. Liners can be individual liners that are placed in each chamber separately or can be a single liner that lines multiple chambers. In some cases, the liner can act as a diaphragm or bladder and be used to modulate the volume of the chamber. The liner can be of inert material that prevents the solution from contacting the inner surface of the chamber and/or reacting with the liner material. This can provide a sterile, clean, inert surface that can contact compounds such as pharmaceuticals that may be subject to stringent manufacturing requirements. A liner also allows for a quick change between different precipitation runs without the need for cleaning or sterilizing the apparatus. Different liner materials can also exhibit various surface energies and hydrophobicity/hydrophilicity that may be less likely to retain crystals when compared to the metallic surface of a chamber. In some cases, liners are flexible and resilient enough that they can withstand repeated flexing from a piston, diaphragm, air pressure, or other volume modulator. The composition of a liner can be tailored for the specific precipitation that is being run. Liners can be, for example, molded, extruded, stamped or die pressed. Appropriate liner materials include flexible materials such as polymer films and injection molded polymers. Examples of specific materials include inert polymers such as PTFE, PPS, PEEK, FEP, PFA, ETFE, POM, EPDM, FKM and FFKM and combinations of these and other polymers.

The individual chambers can be shaped to avoid geometries that might retain crystals/solids or interfere with mixing. For instance, the chambers may include few corners, for example, fewer than eight, fewer than four, fewer than two, or zero. The chambers may also be void of planar walls and may comprise one continuous rounded wall. The wall can include orifices for various inputs and outputs. In various embodiments, one or more of the chambers can be spheroidal, ovoidal and/or ellipsoidal. The chambers can be similarly or identically sized in order to result in similar or identical retention times. The chamber volume is determined in part by the amount of solution that is being processed. In general, production processes will utilize larger chambers than do laboratory scale processes. In various embodiments, the volume of one or more chambers can be less than 1 L, less than 500 mL, less than 250 mL, less than 100 mL, less than 50 mL, greater than 10 mL, greater than 20 mL, greater than 50 mL, greater than 100 mL, greater than 500 mL, greater than 1 L, greater than 5 L or greater than 50 liters. The overall volume of the apparatus, totaling the plurality of chambers, can be less than 5 L, less than 2 L, less than 1 L, less than 500 mL or less than 250 mL. In other cases the total volume is greater than 250 mL, greater than 500 mL, greater than 1 L, greater than 5 L or greater than 50 liters.

In some embodiments chambers can be equipped with structures to promote mixing (turbulence) in the chamber. The structures include baffles that can be, for example, molded or attached to the chamber walls, molded or attached to the liner walls, or attached to a mixing shaft. These mixing structures can be permanent or can be removable from the chambers and can be single use. Baffles may be comprised of inert materials such as metal or polymer. An example of a baffle is a perfluoropolymer sheet including passageways defined therein. The sheet can be mounted, for example, between the two halves of a housing.

A chamber may be in fluid communication with a chamber upstream, a chamber downstream or both. The fluid communication can be achieved by direct overlap of the chambers as shown in FIG. 1 or by using connectors such as tubing or channels molded or machined into the apparatus. The fluid communication connectors may be tubes, connectors or channels within the housing that allow fluid communication between chambers. The pathways can include a check valve. In various embodiments, the volume of these pathways may be less than 50 mL, less than 10 mL, less than 5 mL or less than 1 mL. In some embodiments, channels or connectors can be dimensioned to avoid clogging. For example, a channel or connector may have a length of less than 1, less than ½, less than ¼ or less than 1/10 of the mean diameter of the chamber. In some embodiments the channel is inflexible and is not comprised of tubing or other flexible material. Connecting channels can be wide enough that they do not contribute significant back pressure when the upstream solution is pulsed through a chain of chambers.

One or more of the chambers can be in fluid communication with a volume modulator that can be activated to provide a reduction in chamber volume resulting in a pulse of fluid and crystals that travels downstream through the crystallizing apparatus from chamber to chamber. It can also be retracted to return the chamber to its original volume. The volume modulator can comprise a movable surface that can expand into and retract out of a chamber to alter the volume of the chamber. The volume modulator can comprise, for example, a piston, an inflatable bladder, a diaphragm, a solenoid, a roller or pressurized fluid (e.g., behind a liner). The volume modulator can be controlled by a microprocessor that can be programmed to vary the action of the volume modulator. The parameters that can be controlled include, for example, the amount of volume reduction, the rate of volume reduction, the wait time before retraction of the modulator (increase in volume), the rate of retraction and the amount of retraction. The volume modulator can reduce and/or increase the volume of a chamber by, for instance, greater than 1%, greater than 2%, greater than 5%, greater than 10%, greater than 20% or greater than 30% of the original volume of the chamber. The volume reduction or increase can occur over a time period of from 0.1 s to 10 s, greater than 0.1 s, greater than 10 s, greater than 30 s, less than 60 s, less than 30 s or less than 10 s. The rate of reduction or increase can also vary during a single stroke. For instance, the initial stroke may start slowly, for example, 1 mL/s and may be ramped up by the end of the stroke to 10 mL/s. Alternatively, the stroke could start quickly and taper off at the end. The volume of fluid that is moved by the action of the volume modulator, in absolute amounts, can be, for example, greater than 1 mL, greater than 5 mL, greater than 10 mL or greater than 50 mL. In other embodiments the volume of a single stroke can be, for example, less than 1 L, less than 500 mL, less than 100 mL, less than 50 mL or less than 10 mL. The rate of flow from one chamber to the next, as a result of movement of the volume modulator can be greater than 1 mL/s, greater than 2 mL/s, greater than 5 mL/s, greater than 10 mL/s, less than 50 mL/s, less than 10 mL/s or less than 1 mL/s.

In some embodiments, the apparatus can include means for preventing or reducing backflow from a downstream chamber back to an upstream chamber. These means for preventing backflow can ensure that flow between chambers occurs only in one direction. These means for preventing backflow can include check valves such as gates, valves, constrictors. Means for preventing backflow can assure that both liquid and solids travel in the direction intended thus eliminating back mixing and improving plug flow characteristics. Such a check valve can be achieved in different ways. A passive check valve is one that reacts passively to a change in flow direction. An active check valve is one that is activated externally, such as by a microprocessor or a mechanical interface. In one embodiment, a disk of flexible plastic is mounted on the shaft of the impellers. The disk has diameter larger that the diameter of the gap between the chambers and rests on the surface of the downstream chamber. Upon generation of the volume change responsible for the forward movement of the slurry, the disk is flexed or lifted upward opposing minimal or zero resistance to flow. Once the pulse is over, the disk provides a stop to flow that would like to return back, due to gravity for example, because of its contact with the chamber and a fluid-tight seal between the disk and the shaft. Disks can be anchored or slidably anchored to the shaft with simple restraining devices such as rings connected to the shaft. In such a way the disk cannot slide over the shaft, can only flap up and down to provide flow passage or to prevent it. In another embodiment, a disk or cone or other valving structure is attached to the mixing rod and the entire mixing rod can shift to either open or close the passageways between chambers. Other means to provide flow in a single direction can be arranged such as rigid elements that can slide in a controlled way onto the shaft. Unidirectional flow can be achieved also with elastomeric check valves, and these may or may not be mounted on a shaft. As an example, elastomeric check valves can be used in a device that does not have a shaft because mixing is achieved by a means that does not rely on rotating elements.

FIG. 1 illustrates a piston 180 as an example of a volume modulator. Piston 180 can move laterally to decrease or increase the volume of chamber 110. Similarly, piston 182 can be moved to decrease and increase the volume of terminal chamber 140. Activation of piston 180 results in a pulse of liquid and solids/crystals moving upwardly (as shown) through chambers 120, 130 and 140. As piston 180 is retracted, solution, e.g., supersaturated solution or reagent, can be fed through port 114 to make up the increasing volume that results from the retraction of piston 180. In this manner, back flow through the system can be avoided. Activation of piston 182 results in a pulse of fluid that includes solids/crystals through outlet 170, at which point solids/crystals can be collected. An absence of headspace in chambers 110, 120, 130 and optionally 140 means that any decrease in volume only pushes fluid up and out of the chamber 140. Piston 180 can include a cutaway portion to allow for impeller clearance when the piston is moved into the chamber.

Chambers may be equipped with one or more ports that provide fluid communication with solution, antisolvent, solvents or reagents for example. Antisolvents are one or more fluids that promote precipitation due to very low solubility of the target compound in the fluid. The antisolvent is generally miscible in the solution, but the target compound is only sparingly soluble in the antisolvent. Each chamber can be associated with zero, one, two, three or more ports. Ports may be dedicated to one type of fluid or may be used for two or more different fluids. For example, port 114 can be used to feed either solution or antisolvent to chamber 110 while port 124 can be used exclusively for solution and port 126 is used exclusively for antisolvent. Ports 114, 124, 134, 144 and 126 may include valves and can be in fluid communication with a solution or antisolvent reservoir. Fluid ports may be controlled and plumbed individually or can be plumbed in parallel with a solution source, an antisolvent source or an additive source. Fluid ports may include one-way valves to preclude backflow during an increase in pressure, such as during a pulse.

In some precipitation procedures, and in particular in crystallization procedures, a solution reaches supersaturation prior to crystallization of product. In a linear system, this supersaturation can be achieved in a first chamber, a final chamber or in any chamber or chambers within the linear chain. For example, supersaturation can be achieved by cooling an n^{th} chamber(s) or by injecting antisolvent into an n^{th} chamber(s). In other embodiments, components either in solutions, suspensions, or mixtures are reacted to produce a product that is not soluble and therefore precipitates (in some cases crystallizes) as a result of the reaction. This precipitation or crystallization can be independent of changing parameters such as temperature or antisolvent addition.

In many embodiments, temperature control of one or more chambers can promote precipitation or reaction. For instance, one, two, three or more of the chambers can include cooling. In other embodiments, the entire apparatus can be cooled or heated. Temperature regulation can be implemented through the use of coolant pathways that pass in proximity to the chamber being regulated. For example, a passageway can surround a chamber, and as shown in FIG. 1 at 184a, 184b, 184c and 184d, a passageway can spiral around a chamber to provide efficient temperature regulation. In the embodiment shown, the passageway is not in fluid communication with the chamber and heat transfer occurs between the passageway 184 and the chamber 120 through a portion of the housing material 102. The apparatus can have an external heating or cooling source that can provide heated or cooled fluid to passageway 184. A temperature sensor in the chamber can provide constant temperature readings to assure real time control of the temperature. Temperature can be raised or lowered to a fixed level or can be ramped up or down as the precipitation process progresses. In other embodiments, cooling or heating can be provided by the introduction of cooled or heated solution or antisolvent directly to one or more chambers. Temperature can be different in each of the chambers to achieve temperature gradients beneficial to the precipitation. For example, multiple chambers with plug flow characteristics allow for tighter residence time distribution which reduces the variability in the crystal size and shape.

### Process

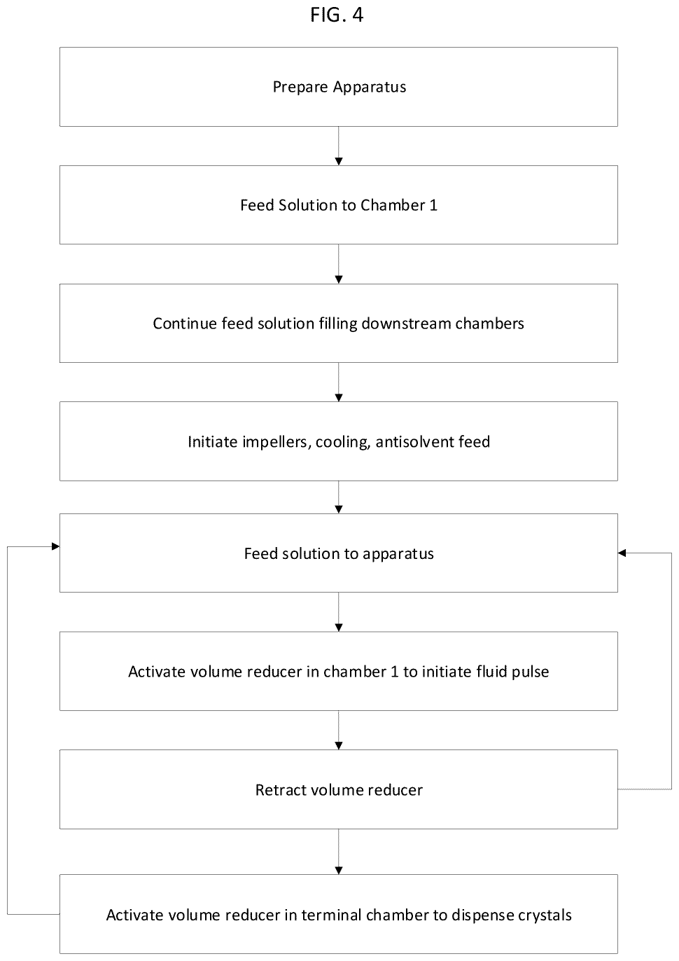

FIG. 4 provides a flow chart illustrating one embodiment of a process for continuous precipitation. The actions described may be optional, duplicated or performed in a different order in other embodiments. The apparatus of FIG. 1 can be referred to in reference to the following process embodiment.

To prepare the apparatus of FIG. 1, housing 102 is assembled by placing complementary halves together and bolting them closed to provide a fluid-tight seal. Feed lines and cooling lines are attached, and any mechanical connections, such as impeller drives, are made. If one or more liners are to be used, the liners can be installed prior to closing and sealing the apparatus.

The first chamber 110 is evacuated of air by filling it with solution via port 114. The solution can be, for example, a supersaturated solution of the compound to be crystallized. After chamber 110 has been filled, the solution continues to fill subsequent chambers 120, 130 and 140. In some cases, there can be a time delay in filling subsequent chambers so that, for example, the solution experiences a specific residence time in each chamber before advancing to the subsequent chamber.

Process promotors such as agitation, antisolvent addition and temperature control (cooling) may be initiated at any time during the process. For instance, impellers can be operated throughout the entire process. Antisolvent addition can take place, for instance, intermittently in one or more chambers, continuously in one or more chambers, or at different times and rates by specific chamber.

Agitation can be used to promote mixing and turbulent flow for improved precipitation. Agitators include, for example, mixers, impellers, blenders, fluid jets and stirring bars. Although the apparatus can also be shaken or vibrated, the absence of headspace and a gas phase in a chamber makes mixing through shaking less effective than direct mechanical agitation. Agitators can be controlled independently or in unison and can be adjusted during precipitation. Similarly, any baffles that may be used can be controlled or positioned independently.

Antisolvent addition can take place in one or more chambers or can be mixed with the solution prior to entry into the first or any other chamber. Antisolvent ports can be plumbed to sources of antisolvent, and the antisolvent can be fed via a pump that is controlled by a microprocessor. Antisolvent flow can be initiated, increased, decreased or ceased depending on instructions from the microprocessor. The microprocessor can monitor various parameters of the solution being crystallized. For example, temperature, turbidity, particle count, flow rates and particle size can be monitored, and the flow of antisolvent can be adjusted in response to, or in anticipation of, changes to one or more of these parameters.

As shown in FIG. 1, individual chambers can be temperature controlled so that the chambers cool or heat the contained solution to above or below ambient temperature. For example, the solution in one or more chambers can be cooled to more than 5, more than 10, more than 15 or more than 20 degrees C. below ambient. In other embodiments, the solution can be heated to more than 5, more than 10, more than 15 or more than 20 degrees C. above ambient. In addition to cooling the chamber housing, the solution itself can be chilled or heated prior to feeding to a specific chamber. Antisolvent can also be heated or cooled prior to being fed into one or more chambers.

To pulse the solution and entrained crystals to a downstream chamber, volume modulator 180 can be actuated. As shown in the embodiment of FIG. 1, the volume modulator is a piston that can be controlled manually or by a microprocessor. When the piston is moved to the right (as shown in FIG. 1) the volume of chamber 110 is reduced and that amount of volume reduction causes an equal volume of solution to be pulsed to the next chamber. The same amount of fluid is pulsed from the second to the third, the third to the fourth, etc., and, if the apparatus is at capacity, an equivalent volume of solution and crystals is dispensed from the final chamber. This pulse of fluid through the system can provide for movement of crystals that would not occur with a constant flow rate through the system. The pulse can also promote turbulent flow, prevent settling of crystals, and remove crystals that may otherwise adhere to the wall of the chamber. As the piston is retracted, the increase in volume can be made up by the flow of solution through port 114. Unlike piston 180, piston 182 does not induce a pulse throughout the apparatus but only pulses fluid out of terminal chamber in which it is in mechanical communication. This terminal chamber pulse can push solution and crystals through outlet 170 but has little or no effect on the upstream flow that is feeding the terminal chamber because of the lack of headspace in the upstream chambers. As piston 182 is retracted, a headspace can develop or enlarge in the terminal chamber, or the volume can be filled by the feed from the upstream chamber. In cases where a check valve is employed, the volume is filled from the upstream chamber.

After crystals have been delivered via outlet 170, the crystals can be isolated, washed and further treated if desired. Crystal isolation can be, for example, via filtration, centrifugation or solvent evaporation. Washing of crystals can be performed using methods known to those of skill in the art.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A continuous chemical processing apparatus comprising:
a linear plurality of chambers including first and last chambers in fluid communication;
an inlet in fluid communication with the first chamber;
a plurality of agitators, each of the plurality of agitators disposed in one of the plurality of chambers; and
wherein at least one of the plurality of chambers is constructed and arranged to hold both a first volume and a second volume, the second volume less than the first volume.

2. The apparatus of claim 1 wherein the first volume is at least 10%, greater than the second volume.

3. The apparatus of claim 2, the first chamber including a volume modulator wherein the volume modulator is configured and arranged to change the volume of the chamber.

4. The apparatus of claim 1 wherein the chambers are in serial fluid communication.

5. The apparatus of claim 1 further comprising a removable liner in contact with a surface of at least one of the plurality of chambers.

6. The apparatus of claim 5 wherein the liner is flexible and flexes when the volume of the first chamber is changed.

7. The apparatus of claim 3 wherein the plurality of chambers is retained in a housing and the housing is comprised of at least one of a metal, an alloy, a ceramic, a polymer and glass.

8. The apparatus of claim 1 wherein the chambers are arranged linearly in relation to one another when the apparatus is in operation.

9. The apparatus of claim 7 wherein the housing comprises a first portion and a second portion, the first and second portions reversibly connected to form a fluid seal.

10. The apparatus of claim 3 including a microprocessor for controlling the volume modulator.

11. The apparatus of claim 10 wherein the volume modulator expands the volume of the chamber at a rate that does not exceed, or is equal to, a rate of fluid inflow.

12. The apparatus of claim 3 wherein the volume modulator comprises at least one of a piston, a bladder, a mechanical roller, a pressurized fluid, a diaphragm and a flexible liner.

13. The apparatus of claim 1 wherein the agitators are driven by a common shaft.

14. The apparatus of claim 1 comprising at least 3 chambers.

15. The apparatus of claim 14 wherein one or more of the chambers are substantially spherical.

16. The apparatus of claim 4 wherein serial chambers are fluidly connected by a passageway connecting one chamber to a next chamber or via direct overlap of the chambers.

17. The apparatus of claim 1 wherein the volume of at least one of the chambers is less than 1 L.

18. The apparatus of claim 1 comprising a volume modulator configured and arranged to change either the first volume, the second volume, or both.

19. The apparatus of claim 18 wherein the volume modulator changes a first volume or a second volume in a first chamber, a final chamber or an intermediate chamber.

20. The apparatus of claim 1 comprising a cooler or heater in thermal communication with one or more chambers.

21.-56. (canceled)
